(19) United States
(12) Patent Application Publication
(10) Pub. No.: US 2013/0070067 A1
(43) Pub. Date: Mar. 21, 2013

(54) Projection System Generating 3D Images

(71) Applicant: Yongjing Wang, Suzhou (CN)

(72) Inventor: Yongjing Wang, Suzhou (CN)

(21) Appl. No.: 13/701,502

(22) PCT Filed: Jun. 1, 2011
(86) PCT No.: PCT/CN2011/000923

§ 371 Date: Dec. 1, 2012

(30) Foreign Application Priority Data
Jun. 2, 2010 (CN) 201010189644.1
Jun. 2, 2010 (CN) 201020212296.0

(51) Int. Cl. H04N 13/04

(52) U.S. Cl. CPC H04N 13/0434
USPC 348/58

(57) ABSTRACT

A projection system generating 3D images comprises: an illumination system, a display panel having two separate regions displaying images for right eye and left eye respectively; a projection lens system that comprising a deflecting unit that deflects the images of left eye and right eye at different angles; and a polarization modulator that modulates the images of different eyes at different polarization states. The viewer wears a piece of passive polarization glasses to see the 3D images. The advantages of present invention are: simple structure and low cost. It produces 3D images by single display panel.

This application is PCP application No. PCT/CN2011/000923, which claims priority of Chinese application No. 201010189644.1 filed on Jun. 2, 2010.

### FIELD OF THE INVENTION

This invention relates to display technology, specifically to a new projection system generating 3D images.

### BACKGROUND ART

The main 3D technologies include 1) Narrow band spectrum method; 2) polarization 3D method; and 3) Temporal multiplexing 3D method.

Narrow band spectrum 3D method is relatively simple. However, there is color separation on the edge of images due to utilizing color filter. Performance of the display is low. It is mainly used in toy applications.

Polarization 3D projection technology. This technology uses two separate projectors to display the images for right eye and left eye. Each image has different polarization state. The viewers wear polarization glasses to see 3D images. The advantage is that the cost of the polarization glasses is low. The disadvantage is that it needs two projectors that not only increase the cost but also increase the difficulty to align two projectors. The 3D display system is difficult to maintain.

Temporal multiplexing 3D. The display panel displays the different images for right eye and left eye at different times. 3D glasses are synchronized with the display panel so the right eye and left eye of viewer only see corresponding images at different times. The disadvantages of this approach are: 1) an active shutter glasses is needed so the cost is high. Currently the active glasses are sold at about $150 in USA. 2) Most of the shutter glasses are based on liquid crystal technology. They cut off 50% of the light therefore the brightness is lower.

### DISCLOSURE OF THE INVENTION

The purpose of present invention is to provide a low cost 3D projection system. The viewer only wears a piece of passive polarization glasses to see 3D images.

Present invention discloses a 3D projection display system. It comprises 1) an illumination system that illuminate a display panel; 2) a display panel wherein the images for right eye and left eye are displayed on different regions of the display panel; 3) an optical projection lens system that projects the image of the display panel onto the screen. It further comprises a deflection unit that deflects the images of right eye and left eye at different angles so that the images of right eye and left eye are converged on the screen. The viewer wears a piece of glasses that have polarizers at different angles for right eye and left eye. Therefore the right eye sees the image of right eye; the left eye sees the image of left eye. 3D image is generated.

Following is further description of present invention:

For simplicity, the above description is only a solution for monochrome 3D image. To implement color 3D images, the methods well-known to those skilled in the art can be used, including:

Color sequential method. The display panel displays red, green and blue images sequentially and rapidly. The viewer's brain mergers red green and blue images to a full color image.

Spatial color method. The system comprises three display panels that display red green and blue image respectively. According to present invention, the red display panel is further split into two regions to display the images for right eye and left eye. The green display panel is further split into two regions to display the images for right eye and left eye. The blue display panel is further split s into two regions to display the images for right eye and left eye. There is further a color combination unit in the system to combine red, green and blue images into a full color image. In the mean time, the deflection unit in the system merges the images for right eye and left eye to a 3D image.

Spatial color method with micro color filter. Each pixel in the display panel is split in to red, green and blue sub pixel to display the information of red green and blue images. According to present invention, the right region and left region of the display panel display the images of right eye and left eye. The sub pixel is too small to be distinguished by human's eyes therefore a full color image is formed. In the mean time, the deflection unit in the system merges the images of the right eye and left eye to a 3D image.

In one embodiment of present invention, the right region and left region of the display panel generate light at different polarization states. In a liquid crystal based display panel, different polarizers are placed onto the different regions. In an MEMS (Micro Electro Mechanical systems) based display panel, there are two methods to generate different polarization states in different regions. 1) Different polarizers are placed onto different regions of the display panel. 2) A polarization light splitting component is added in the illumination system, therefore the right region of said display panel is only illuminated by light with one polarization state and the left region of said display panel is illuminated by light with another polarization state. The polarization loss of the light in this method is smaller than that in the first method.

Alternatively, the right region and left region of the display panel generate the light in the same polarization state. A polarization modification unit such as wave plate or polarizer is placed in the projection lens system to change the polarization state of different regions to different polarization state. There is a location in the projection lens system where the light from right region of the display panel and the light from left region of the display panel are fully separated. A wave plate is placed at this location to modify the light from the different regions of the display panel to different polarization stage.

No matter which method is used, the ultimate effect is that the images on the screen for different eyes have different polarization states. Therefore the viewer can wear a piece of polarization glasses to make sure the right eye only sees the image from one region of the display panel, and the left eye only sees the image from another region of the display panel. Therefore a 3D image is generated.

The light source of the illumination system in present invention includes but not limited to, HID (high intensity discharge) lamp, LED, and laser.

The display panel in present invention includes but not limited to, LCD, MEMS, LCOS (Liquid crystal on silicon) and organic light-emitting diode (OLED). The display panel works in reflection way, transmittance way, or self emitting way.

Alternatively, the right region and left region on said display panel are two separate display panels placed substantially close to each other. The two separate display panels display the images for right eye and left eye. This is an equivalent form of a single display panel with two different regions. Therefore, in all embodiments of present invention, the single display panel with two regions can be replaced by two panels placed substantially close to each other. Those skilled in the art should also realize that such equivalent constructions do not depart from the spirit and scope of the invention in its broadest form.

There is a location in the projection lens system where the lights from different regions of the display panel are fully separated. A deflection unit is placed at this location to deflect the images for different eyes at different angles therefore they are converged together on the screen or in the eyes. In one embodiment, the deflecting unit is two mirrors placed side by side but at slightly different angles.

The present invention further comprises an electronic driving system. The electronics driving system further comprises 1)an input unit that receives analog or digital 3D image signal; 2) an unit that separates the signals for different eyes; 2) an units that applies different distortions on the different images to compensate distortion made by optical system; 3) an unit that sends processed signal to different regions of the display panel.

The present invention further comprises a polarization glasses for the viewer.

There are several advantages of current invention:

1) There is only one projector. The cost is low. Volume is small. And maintenance is easy.

The viewer only needs to wear a low cost polarization glasses.

The images of right eye and left eye are displayed simultaneously. The loss due to polarization is low and the picture quality is better.

### BRIEF DESCRIPTION OF THE DRAWINGS

FIG. 1 is a schematic diagram of the present invention wherein a monochrome 3D picture is generated. 101 illumination system; 103 the left region of the display panel; 105 the right region of the display panel; 111 the first lens unit of the projection system; 118 the second lens unit of the projection system; 113 and 117 mirrors; 119 projection screen;

FIG. 2 is a schematic diagram of the present invention wherein three display panels are used to generate full color 3D image. 201 illumination system; 203 the left region of the red display panel; 205 the right region of the red display panel; 211 the right region of the green display panel; 213 the left region of the green display panel; 207 the right region of the blue display panel; 209 the left region of the blue display panel; 215 color combination unit. 217 projection lens system; 219 projection screen;

FIG. 3 is a schematic diagram of electronics driving function chart of the present invention.

FIG. 4 is a schematic diagram of the present invention wherein a reflective panel is used as the display panel. 401 the light from illumination system; 403 TIR (total internal reflection) prism; 405 MEMS display panel; 407 the left region of MEMS display panel; 409 the right region of MEMS display panel; 411 projection lens system; 413 projection screen;

FIG. 5 is a schematic diagram wherein the polarization modification unit is placed on the panel. 501 display panel; 507 the left region of the display panel; 509 the right region of the display panel; 511 the light from left eye image; 513 the light from right eye image; 503 wave plate;

FIG. 6 is a schematic diagram wherein the polarization modification unit is placed on the mirror. 601 light from the left region of the display panel; 603 light from the right region of the display panel; 605 and 607 mirror; 609 wave plate; 611 output light from the left region of the display panel; 613 output light from the right region of the display panel.

### BEST MODE FOR CARRYING OUT THE INVENTION

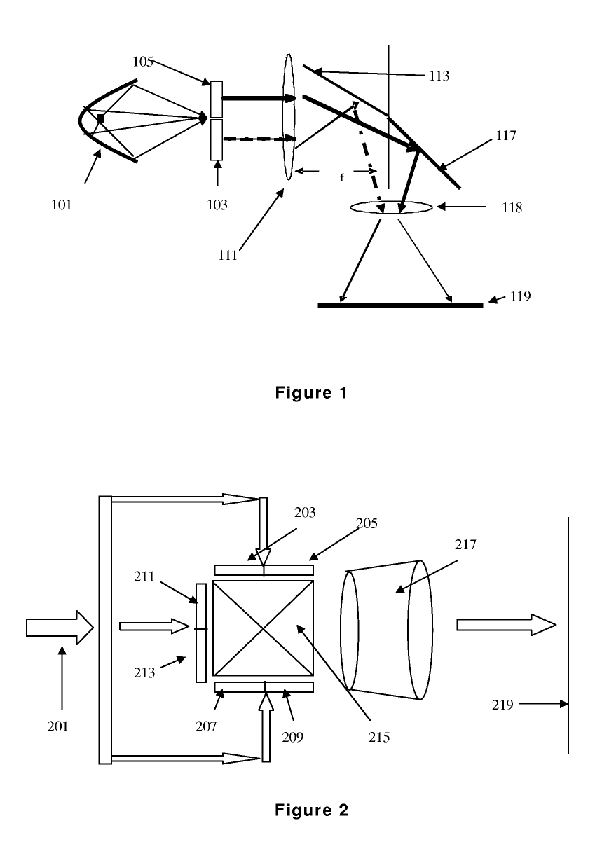

The first embodiment wherein a monochrome 3D image is generated is shown in FIG. 1. The illumination system 101 illuminates a display panel (103 and 105). The display panel comprises right region 103 and left region 107. 103 and 107 display the images for right eye and left eye respectively. The images for different eyes are located at different height. The difference of height is d. In another word, the 3D information is encoded by height. The light from the display panel then enters into the first lens unit (111) of the projection lens system with an effective focal length of f. 111 comprises at least one lens. Because the height of the left region 103 and right region 105 are different, the lights from region 103 and region 107 are tilted at different angles after passing the first lens unit 111. i.e. the images for different eyes are encoded by angle. 113 and 117 are two mirrors tiled at different angles and placed side by side. The light from the left region 103 is incident onto the mirror 113. The light from the right region 105 is incident onto the mirror 117. The light from the region 103 and the light from region 105 are fully separated without overlapping at the position of the mirrors. The mirror 113 and mirror 117 reflect the light for the right eye and left eye by different angles to merger them on the screen.

The lights for different eyes are fully separated at two locations in the system. The first location is on the panel. Region 103 is for left eye only and the region 105 is for right eye only. The second location is on the mirrors. 113 is for left eye only and 117 is for right eye only. Polarization modulation components such as wave plates or polarizers can be placed at either two locations to change the polarization stages of light so that the light for right eye and the light for left eye have different polarization stages. The viewer wears a piece of polarization glasses wherein the polarization directions are different for right eye and left eye. Therefore the right eye only sees the image for right eye. The left eye only sees the image for left eye. 3D images are generated in this way.

The light source of the illumination system in present invention includes but not limited to, HID (high intensity discharge) lamp, LED, and laser. The display panel in present invention includes but not limited to, LCD, MEMS, LCOS (Liquid crystal on silicon) and organic light-emitting diode (OLED). The display panel works in reflection way, transmittance way, or self emitting way.

In another embodiment, the right region and left region on the display panel are two separate display panels placed substantially close to each other. The two separate display panels display the images for right eye and left eye. This is an equivalent form of a single panel with two different regions. Therefore, in all embodiments of present invention, the single display panel with two regions can be replaced by two display panels placed substantially close to each other. Those skilled in the art should also realize that such equivalent constructions do not depart from the spirit and scope of the invention in its broadest form.

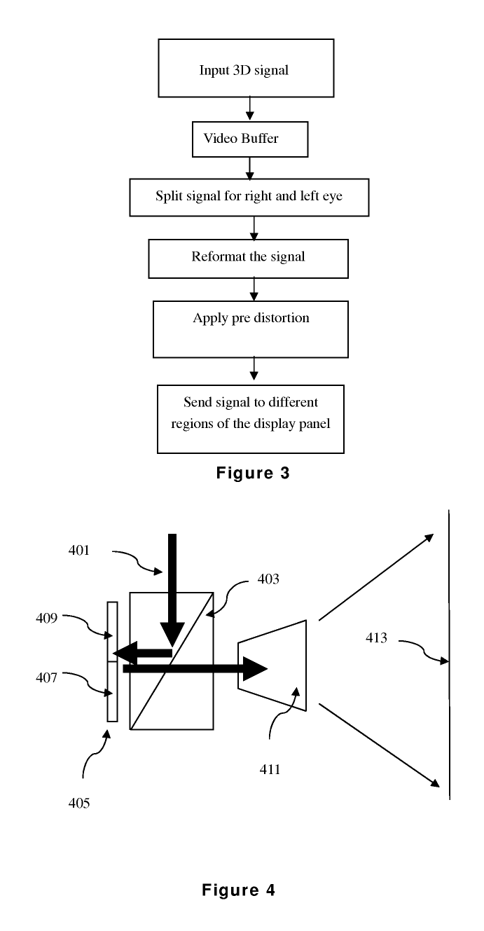

FIG. 1 only shows the optical system layout of present invention. The full system of present invention further comprises an electronics driving system. The electronics driving system further comprises an image processing system that can be implemented by hardware and/or software. FIG. 3 is a schematic diagram of electronics driving function chart of the present invention. The input signal is 3D signal in digital or analog format. It is saved first then the information for different eyes are separated and pre-distorted according to a pre-determined distortion table. The distortion table is determined to compensate the distortion generated by the optical system. Then the signals for different eyes are sent to different regions of the display panel for display. There are alternative orders of the processing function chart. Those skilled in the art should also realize that such equivalent constructions do not depart from the spirit and scope of the invention in its broadest form.

For simplicity, the above description is only for a monochrome 3D image system. To implement color 3D image, the method well-known to those in the art can be used to implement color 3D image, including Color sequential method, spatial color method and spatial color method with micro color filter.

In another embodiment, color sequential method is used to generate color 3D image. The display panel in FIG. 1 displays red green and blue images sequentially and rapidly. The viewer's brain mergers red green and blue images to a full color image.

In another embodiment, the spatial color method with micro color filter is used to generate color 3D image. Each pixel in the display panel in FIG. 1 is split in to red, green and blue sub pixel to display the information of red green and blue image. The sub pixel is too small to be distinguished by human's eyes therefore a full color image is formed.

In another embodiment, three panels method is used to generate color 3D image. As shown in FIG. 2, the light from illumination system 201 is split into red green, and blue three beams. Red green and blue beams illuminate three display panels respectively. Each display panel is further split into two regions to display the images for right eye and left eye. (the left region of red panel is marked by 203 and the right region of the red panel is marked by 205; the left region of green panel is marked by 211 and the right region of the green panel is marked by 213; the left region of blue panel is marked by 207 and the right region of the blue panel is marked by 209)

Three display panels display the red, green and blue image respectively. A color combination unit mergers the red green and blue image to a full color image. The projection lens system 217 is same as the projection lens system in FIG. 1. The projection lens system 217 merges the images for right eye and left eye to a 3D image on the screen 219. The color combination unit 215 can be implemented by multiple layer coating. Both color and polarization need to be considered in the multiple layer coating design.

FIG. 4 is another embodiment based on reflective display panels. The reflective panels include MEMS and LCOS technology. MEMS is used for an example in following description. The light from illumination system 401 is incident on the MEMS display panel 405 through a total internal reflection prism 403. The display panel 405 is split into the right region 407 and left region 409 to display the images for right eye and left eye. The projection lens system 411 has similar design as in FIG. 1. It comprises the first lens unit 111; the second lens unit 118, and mirrors 113 and 117. The mirrors deflect the images for the right eye and the left eye at different angles to form a 3D image on the screen. The viewer sees 3D image through a polarization glasses.

In all embodiments of present invention, the images for the different eyes are distinguished by different polarizations. The viewer sees a 3D image by wearing a piece of glasses with different polarization states. The lights for different eyes are fully separated at two locations in the system. The first location is on the panel. The second location is on the mirrors. Therefore polarization modulation components such as wave plates can be placed at these two locations to change the polarization stage of lights so that the light for right eye and the light for left eye have different polarization stages. The viewer wears a piece of polarization glasses where the polarization direction is different for right eye and left eye. Therefore the right eye only sees the image for right eye. The left eye only sees the image for left eye. 3D images are generated in this way.

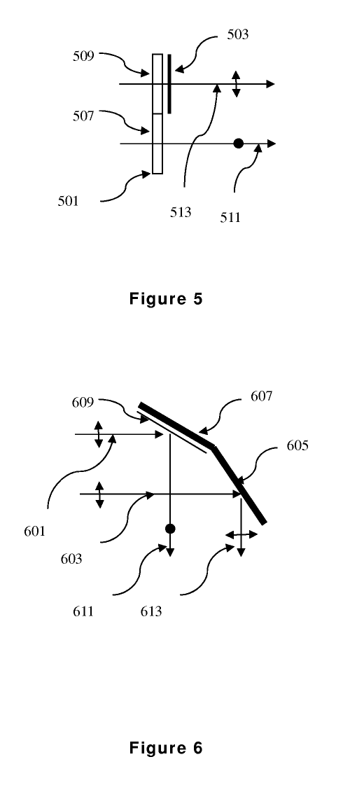

FIG. 5 shows an embodiment where the polarization state is modified on the location of the display panel. The display panel 501 is based on liquid crystal. By adding different polarizers on the left region 507 of the display pane and the right region 509 of the display panel, the image for the left eye 511 and the image for the right eye 513 have different polarization states.

An alternative embodiment where the polarization state is also modified on the location of the display panel. However the MEMS display panel is used instead of an liquid crystal based display panel. The MEMS display panel doesn't require any polarizer by itself. However the polarized light can be generated from illumination system such that the left region and the right region of the MEMS panel have different polarization states.

Another embodiment where the polarization state is modified on the location of the mirrors is shown in FIG. 6. The lights from the right region 601 and the light from left region 603 have the same polarization state. The mirror 605 reflects light 603 and mirror 607 reflect light 601. A wave plate 609 is added onto the mirror 607 to modify the polarization state of the light 601. Therefore the polarization of output light 611 and 613 are different.

Those skilled in the art should appreciate that there are many different forms of the illumination system, the display panel, and the projection lens. Those skilled in the art should realize that different combinations of these components do not depart from the spirit and scope of the invention in its broadest form.

1. A system generating 3D images comprises:
a) at least one display panel having two separate regions displaying images for right eye and left eye respectively;
b) a deflecting unit that can deflect the images for left eye and right eye at different angles to converge them to a 3D image on the screen or human's eyes.
c) a polarization modulator that give the images of different eyes different polarization states;
d) and a projection lens system.

2. The system generating 3D image as specified in claim 1 wherein said display panel displays different color at different time to generate full color 3D images.

3. The system generating 3D image as specified in claim 1 wherein said display panels comprises red green and blue display panels wherein the right region and left region of each panel display different images for right eye and left eye; and a color combination unit that merge three different color image into a full color 3D image.

4. The system generating 3D image as specified in claim 1 wherein said deflecting units are two reflecting mirror, said mirrors are placed at the location where the light from left region and right region of said display panels are fully separated.

5. The system generating 3D image as specified in claim 1 wherein the right and left regions of said display panels generate lights at different polarization states.

6. The system generating 3D image as specified in claim 1 wherein the right and left regions of said display panels generate the lights at the same polarization states; and further comprises a polarization modulating component at the location where the lights from right and left portion of the panels are fully separated.

7. The system generating 3D image as specified in claim 1 further comprises a electronic image processing system, said electronic image processing system further comprises: 1) input unit receiving digital or analog 3D signal; 2) a unit separating the signals for right eye and left eye; 3) a unit correcting the distortion of the images for right eye and left eye; and a unit sending said different signals to different region of said display panels.

8. The system generating 3D image as specified in claim 1 said display panels are two separate panels displaying images for right eye and left eye; said display panels are placed substantially on a same plane and close to each other.

9. The system generating 3D image as specified in claim 1 further comprises a polarization glasses.

10. The system generating 3D image as specified in claim 1 said polarization modulator applies different polarization states onto the light from right region and left region of said display panels.
